(19) United States
(12) Patent Application Publication
(10) Pub. No.: US 2008/0112572 A1
(43) Pub. Date: May 15, 2008

(54) EARPHONE AND MEDIA PLAYER

(75) Inventors: SHIH-FANG WONG, Tu-Cheng (TW); TSUNG-JEN CHUANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/876,784

(22) Filed: Oct. 23, 2007

(30) Foreign Application Priority Data
Nov. 10, 2006 (CN) 200610063573.4

(51) Int. Cl. H04R 1/10; H04R 25/00

(52) U.S. Cl. 381/74; 381/380

(57) ABSTRACT

An earphone and a media player are provided. The earphone includes an identification (ID) contact and an identification resistor (RID) connected to the ID contact. The media player includes an earphone jack, an audio playing unit, a processor, a memory, an analog to digital (A/D) converter, and a detecting unit. The media player determines a type of the earphone by detecting the resistance of the RID, and selects a corresponding equalizer parameter of the media player in accordance with the type of the earphone, thus to obtain an audio effects that best utilizes the earphone.

### BACKGROUND OF THE INVENTION

1. Field of the Invention

The present invention relates to earphones, and particularly to an earphone that can adjust an equalizer parameter of a media player according to the type of the earphone.

2. Description of Related Art

Generally, earphones are used to listen to music played by a media player. However, the state of the art media player cannot determine the type of earphone inserted in the earphone jack of the media player. As such, the media player cannot adjust the equalizer's parameter, of music files, according to the type of earphone.

United States Patent Application Publication No. 20050201568, entitled “Headset Detector In A Device Generating Audio Signals” discloses a detector circuit that detects whether a headset is present (inserted) in a jack of a media player by measuring the impedance between connection points of the jack. The detector circuit also determines whether the headset (e.g., is a cellular headset, a stereo headset or a stereo+cellular headset) using the same method of measuring the impedance between the connection points of the jack. However, the media player cannot adjust the equalizer parameters according to the type of the earphone, thereby obtaining a good audio effect.

### SUMMARY OF INVENTION

An earphone and a media player using the same is provided. The earphone includes a right transducer, a left transducer, an identification resistor and an earphone plug. The earphone plug further includes an identification contact for connecting the identification resistor. The media player includes an earphone jack with a first contact, and configured for outputting audio signals; an audio playing unit for playing audio files and outputting the audio signals to the earphone jack; a memory for storing a table defining relationships among a plurality of predetermined resistances, earphone types and equalizer parameters of the media player; a detecting unit for detecting resistance of an identification resistor of an earphone inserted into the earphone jack; an A/D converter for converting a detected resistance of the identification resistor to a digital value; and a processor for determining a type of the earphone according to the digital value, selecting an equalizer parameter corresponding to the earphone type according to the table, and controlling the audio playing unit to output the audio signals in accordance with the equalizer parameter.

### BRIEF DESCRIPTION OF DRAWINGS

FIG. 1 shows a schematic diagram of an audio plug of an earphone in accordance with a preferred embodiment of the present invention;

FIG. 2 shows circuit diagram of a left transducer, a right transducer, and an ID resistor of the earphone in accordance with the preferred embodiment of the present invention;

FIG. 3 shows the audio plug of FIG. 1 coupled with a media player;

FIG. 4 shows a block diagram of the media player of FIG. 3 in accordance with a preferred embodiment of the present invention; and

FIG. 5 shows a table of predetermined resistances, earphone types, and equalizer parameters stored in the media player of FIG. 3.

### DETAILED DESCRIPTION OF THE EMBODIMENTS

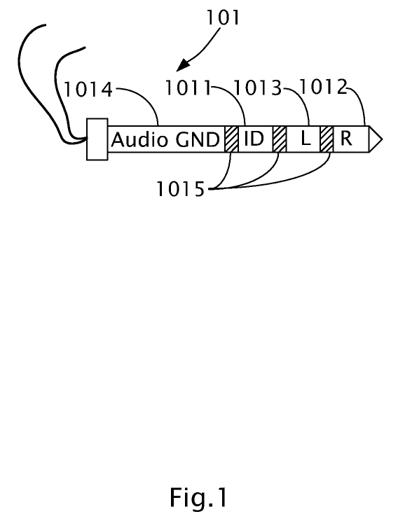

FIG. 1 shows a schematic diagram of an earphone plug in accordance with a preferred embodiment of the present invention. In addition to earphones, the earphone plug 101 can be configured for pairs of audio output transducers such as speakers etc. The earphone plug 101 includes an identification (ID) contact 1011, a right (R) contact 1012, a left (L) contact 1013 and an audio ground (GND) contact 1014. The contacts are isolated from each other by dielectric materials 1015.

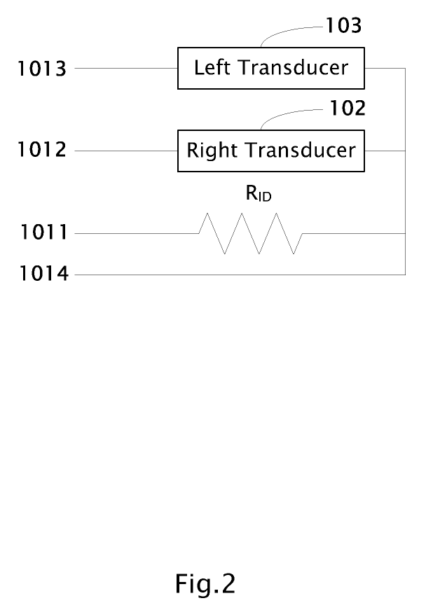

FIG. 2 shows a circuit diagram of a left transducer, a right transducer and an ID resistor of the earphone. The identification resistor RID (hereinafter “the RID”) connects between the ID contact 1011 and the GND contact 1014; the left transducer 103 connects between the L contact 1013 and the GND contact 1014; and the right transducer 102 connects between the R contact 1012 and the GND contact 1014. The RID, left transducer 103 and right transducer 102 are parallel coupled to the earphone plug 101.

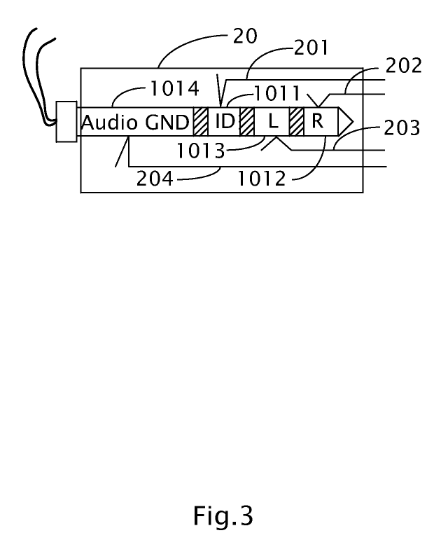

FIG. 3 shows a connection between the earphone and a media player. The media player includes an earphone jack 20. The earphone jack 20 includes a first contact 201, a second contact 202, a third contact 203, and a fourth contact 204. The earphone jack 20 is configured to receptively connect to the 101. When the earphone plug 101 is inserted into the earphone jack 20, the ID contact 1011 and the first contact 201 connects to each other, thus, the first contact 201 can detect the resistance of the R_{ID}. Furthermore, the R, L and GND contacts 1012, 1013, 1014 also become connected with the second, third and fourth contacts 202, 203, 204 of the earphone jack 20, respectively. The earphone plug 101 is able to receive audio signals from the media player.

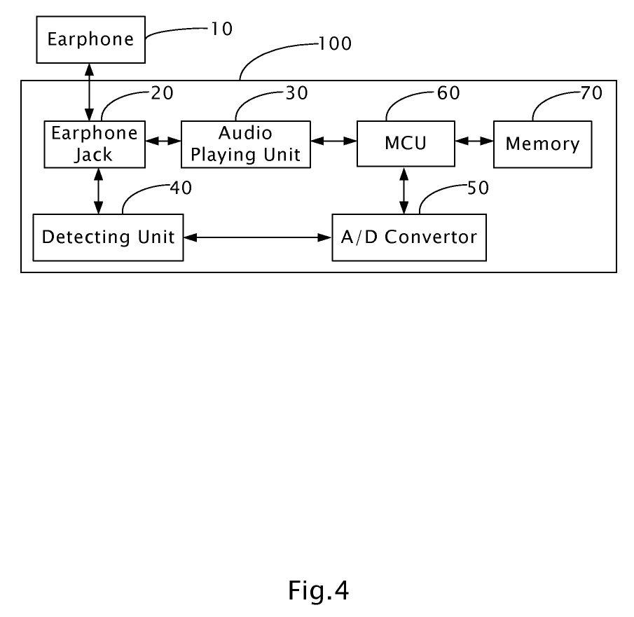

FIG. 4 shows a block diagram of the media player in accordance with a preferred embodiment of the present invention. The media player 100 includes the earphone jack 20 configured for outputting audio signals, an audio playing unit 30 for playing audio files, a detecting unit 40, an A/D (analogy to digital) converter 50, a processor 60 and a memory 70. The audio playing unit 30 is connected between the processor 60 and the earphone jack 20, and is used for outputting audio signals to the earphone jack 20. The detecting unit 40 is connected between the earphone jack 20 and the A/D converter 50, and is used for detecting the resistance of the RID of the earphone 10. The memory 70 is configured for storing software to operate the media player 100. The memory 70 is further configured for storing a table that lists predetermined resistances, earphone types and equalizer parameters.

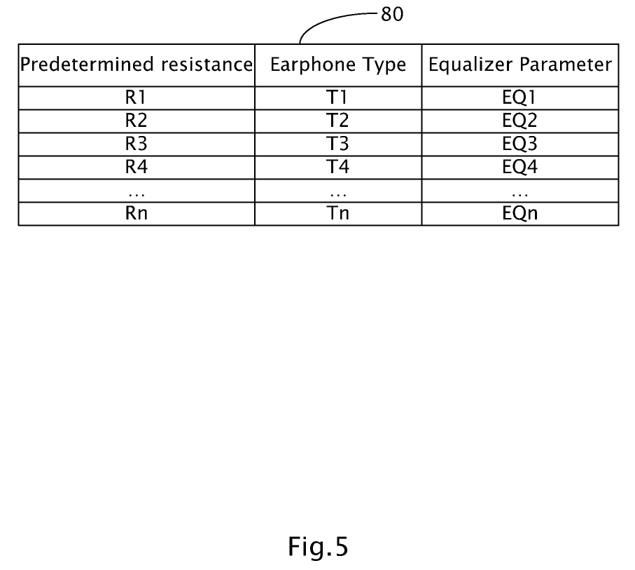

FIG. 5 shows the table of predetermined resistances, earphone types and equalizer parameters. The table 80 records relationships among a plurality of predetermined resistances (R1, R2, R3, R4, . . . Rn), earphone types (T1, T2, T3, T4, . . . Tn) and equalizer parameters (EQ1, EQ2, EQ3, EQ4, . . . EQn) of the media player 100. The media player 100 detects the type of the earphone 10 according to the RID of the earphone 10, and selects a corresponding equalizer parameter from the table 80.

The detecting unit 40 detects the resistance of the RID of the earphone 10, and output a detected resistance to the A/D converter 50. The A/D converter 50 converts the detected resistance to a digital value. The processor 60 receives the digital value and looks up the table 80 to determine the earphone type of the earphone 10. The processor 60 further selects a corresponding equalizer parameter according to the type of the earphone, and outputs audio signals of an audio file according to the equalizer parameter to the earphone jack 20. For example, if the digital value of the RID is equal to the predetermined resistance R1, the media player 100 determines the earphone type is of type T1 and selects the equalizer parameter EQ1 corresponding to T1 earphones to the audio playing unit 30. The audio playing unit 30 outputs audio signals in accordance with the equalizer parameter EQ1. In the same way, when the resistance of the RID equals to the predetermined resistance R2, R3, R4 or Rn, the media player 100 determines the earphone type is of type T2, T3, T4 or Tn, and the processor 60 selects the equalizer parameter EQ2, EQ3, EQ4 or EQn respectively corresponding to the type T2, T3, T4 or Tn earphones to the audio playing unit 30. The audio playing unit 30 outputs audio signals according to the equalizer parameters EQ₂, EQ₃, EQ₄ and EQn through the earphone 10, thereby obtaining an audio effect that best utilizes the earphone.

Although the present invention has been specifically described on the basis of a preferred embodiment and method thereof, the invention is not to be construed as being limited thereto. Various changes or modifications may be made to the embodiments without departing from the scope and spirit of the invention.

What is claimed is:

1. A media player comprising:
an earphone jack for outputting audio signals;
an audio playing unit for playing audio files and outputting the audio signals to the earphone jack;
a memory for storing a table defining relationships among a plurality of predetermined resistances, earphone types and equalizer parameters of the media player;
a detecting unit for detecting a resistance of an identification resistor of an earphone inserted into the earphone jack;
an A/D converter for converting the resistance of the identification resistor to a digital value; and
a processor for determining a type of the earphone according to the digital value, selecting an equalizer parameter corresponding to the earphone type according to the table, and controlling the audio playing unit to output the audio signals in accordance with the equalizer parameter.

2. The media player as claimed in claim 1, wherein the earphone jack comprises a first contact connected with an identification contact which connects with the identification resistor of the earphone.

3. A media player comprising:
an earphone jack for outputting audio signals and comprising a first contact;
an audio playing unit for playing audio files and outputting the audio signals to the earphone jack;
a memory for storing a table defining relationships among a plurality of predetermined resistances, earphone types and equalizer parameters of the media player;
an earphone comprising an earphone plug inserted into the earphone jack, the earphone plug comprising an identification contact and an identification resistor, the identification contact connecting the identification resistor to the first contact of the earphone jack;
a detecting unit for detecting resistance of an identification resistor of an earphone inserted into the earphone jack;
an A/D converter used for converting the detected resistance of the identification resistor to a digital value; and
a processor for determining a type of the earphone according to the digital value, selecting an equalizer parameter corresponding to the earphone type according to the table, and controlling the audio playing unit to output the audio signals in accordance with the equalizer parameter.

4. The media player as claimed in claim 3, the earphone further comprising a right transducer, a left transducer and audio ground contact, the right transducer, the left transducer and the identification resistor are parallel coupled to the audio ground contact.

5. The media player as claimed in claim 4, wherein the identification contact is insulated from the audio ground contact by a dielectric material.

6. A earphone comprising:
an earphone plug, comprising:
an identification contact;
an identification resistor for identifying a type of the earphone;
the identification contact for connecting the identification resistor to a detecting unit of a media player when the earphone plug in inserted in the media player, so that the media player detects the identification resistor, and determines the type of the earphone according to the identification resistor.

7. The earphone as claimed in claim 6, wherein the identification resistor, the right transducer and the left transducer are parallel coupled to the audio ground contact.

8. The earphone as claimed in claim 6, wherein the identification contact is insulated from the audio ground contact by a dielectric material.
